(19) United States
(12) Patent Application Publication
(10) Pub. No.: US 2020/0022341 A1
(43) Pub. Date: Jan. 23, 2020

(54) COMBINED STRUCTURE OF A FISHING NET CAGE AND FLOATING WIND TURBINE FOUNDATION AND CONSTRUCTION METHOD FOR SAME

(71) Applicant: PowerChina Huadong Engineering Corporation Limited, Hangzhou (CN)

(72) Inventors: Wei LI, Hangzhou (CN); Chunsheng ZHANG, Hangzhou (CN); Haifeng QI, Hangzhou (CN); Danshan WANG, Hangzhou (CN); Shengxiao ZHAO, Hangzhou (CN); Gen XIONG, Hangzhou (CN)

(21) Appl. No.: 16/122,657

(22) Filed: Sep. 5, 2018

(30) Foreign Application Priority Data
Jul. 23, 2018 (CN) 201810809883.9
Jul. 23, 2018 (CN) 201821164006.2

(51) Int. Cl. A01K 61/65; A01K 74/00; F03D 13/25

(52) U.S. Cl. CPC A01K 61/65; A01K 61/10; F03D 13/25; A01K 74/00

(57) ABSTRACT

Disclosed is a combined structure of a fishing net cage and floating wind turbine foundation. The combined structure includes a wind turbine and a polygonal deep-sea fishing net cage floating body. The polygonal deep-sea fishing net cage floating body comprises an upper polygonal floating body frame, a bottom ring beam, and a middle truss structure, and a connecting column disposed between the upper polygonal floating body frame and the bottom ring beam. A connection structure of the wind turbine set is disposed on the upper polygonal floating body frame. The bottom of the polygonal deep-sea fishing cage floating body is provided with an interface connected with a steel cable of a mooring system. A sub-tank capable of providing ballast by loading water and buoyancy is disposed in the polygonal deep-sea fishing net cage floating body.

### CROSS-REFERENCE TO RELATED APPLICATIONS

This application claims to Chinese application No. 201810809883.9 with a filing date of Jul. 23, 2018 and Chinese application No. 201821164006.2 with a filing date of Jul. 23, 2018. The content of the aforementioned applications, including any intervening amendments thereto, are incorporated herein by reference.

### TECHNICAL FIELD

The present invention relates to a combined structure of a fishing net cage and floating wind turbine foundation, which is suitable for offshore wind power generation, fisheries aquaculture in marine ranching and is suitable for a sea area with water depth over 50 m.

### BACKGROUND OF THE PRESENT INVENTION

The development and utilization of resources in a sea area with depth of more than 50 m is a trend for building a strong marine power. Deep-sea wind power development and utilization and fisheries aquaculture in deep-sea marine ranching have become hot spots. For the deep-sea area, a floating wind turbine foundation may be more economical than a conventional fixed wind turbine foundation. Considering a combination of offshore wind power generation and fisheries aquaculture in marine ranching is of great significance for shortening the cost recovery period and generating related profits.

### SUMMARY OF THE PRESENT INVENTION

The technical problem to be solved by the present invention is to provide a combined structure of a fishing net cage and floating wind turbine foundation, which can be applied to a wind farm and fisheries aquaculture in marine ranching in an area with depth greater than or equal to 50 m. In addition, the structure is also convenient for construction and installation, and economical to operate. Therefore, the technical solutions adopted by the present invention are as follows:

a combined structure of a fishing net cage and floating wind turbine foundation, including a wind turbine set, a polygonal deep-sea fishing net cage floating body and a mooring system.

The polygonal deep-sea fishing net cage floating body includes an upper polygonal floating body frame, a bottom ring beam, and a middle truss structure between the upper polygonal floating body frame and the bottom ring beam; the middle truss structure includes connecting columns, and the connecting columns are disposed between the upper polygonal floating body frame and the bottom ring beam; a connection structure of the wind turbine set is disposed on the upper polygonal floating body frame; The bottom of the polygonal deep-sea fishing cage floating body is provided with an interface connected with a steel rope or cable of the mooring system; and

buoyancy of the polygonal deep-sea fishing cage floating body is adjustable, and in which a sub-tank capable of loading water and providing buoyancy is disposed.

On the basis of adopting the above technical solutions, the following further technical solutions or a combinatorial application of these further technical solutions may also be adopted by the present invention:

the connection structure of the wind power set is disposed on a polygonal corner or inflection point of the upper polygonal floating body frame, and preferably, the column is disposed to connect the polygonal corner or the inflection point of the upper polygonal floating body frame and the bottom ring beam;

the shape of the bottom ring beam may be a polygon consistent with the upper polygonal floating body frame, and the column is disposed to connect the corner point or the inflection point of the upper polygonal floating body frame and a corresponding corner point or an inflection point of the bottom ring beam;

preferably, the column is disposed directly below the connecting structure and is coaxial with a tower barrel of the wind turbine set;

the bottom ring beam is provided with the interface connected with the steel rope or cable of the mooring system;

the mooring system includes a structure fixed to the seabed (such as gravity block, pile and negative pressure cylinder) and an anchor cable (steel rope/cable);

inner region of the polygonal deep-sea fishing net cage floating body provides a culture area, and a mesh of the polygonal deep-sea fishing net cage floating body is connected with the polygonal deep-sea fishing net cage floating body;

buoyancy of the polygonal floating body frame is adjustable, and in which a sub-tank capable of providing ballast by loading water and buoyancy is disposed.

a corner-shaped buoyancy chamber is disposed at the polygonal corner of the upper polygonal floating body frame; and

a maximum buoyancy provided by the buoyancy chamber (disposed at the upper polygonal floating body frame, the bottom ring beam, and the middle truss structure as needed) of the polygonal deep-sea fishing net cage floating body can not only meet the floating of the combined structure to the deep-sea area for installation, but also can provide required buoyancy and ballast (including water injection ballast) for stability of the overall structure during the operation period (power generation of wind turbine set, fisheries cage aquaculture) after in place.

Another technical problem to be solved by the present invention is to provide a convenient construction and installation method for a floating offshore wind turbine set. Therefore, the following technical solutions are adopted by the present invention:

a construction method of a floating offshore wind turbine set is characterized in that:

(1). any one of the above-mentioned polygonal deep-sea fishing net cage floating body may be used as the foundation of the wind turbine set, and the floating body is prefabricated by the onshore processing plant and connected with the wind turbine set through the connection structure; the wind turbine set is installed at the corner of the upper polygonal floating body frame, and then floated by a tugboat to a deep-sea anchorage position after the buoyancy has been adjusted.

(2). when the wind turbine set is floated to the deep-sea anchorage position, the buoyancy is adjusted by loading water ballast into a corresponding buoyancy chamber of the polygonal deep-sea fishing net cage floating body, and the floating body is fixed by a steel cable with a previously constructed mooring system and then a required elevation is adjusted as designed to meet stability requirements for an operation of wind turbine.

The present invention has the following advantages: the combination of offshore wind power generation and fisheries aquaculture in marine ranching may greatly shorten the cost recovery period, and specifically, fisheries aquaculture is lucrative and power generation from new energy is more economical; the net cage body provided with a mesh can improve the dynamic characteristics of the overall structure in terms of hydrodynamics, thereby enhancing the stability of the overall structure; adopting a floating foundation structure is suitable for a deep-sea area with a water depth greater than 50 m; the combined structure is stable and the forced capacity is good; and it can be prefabricated onshore, transported by floating, which can reduce the offshore operation amount and make the transportation convenient; furthermore, a plurality of wind turbines can be installed at the same time.

### BRIEF DESCRIPTION OF THE DRAWINGS

FIG. 1 is a perspective view according to an embodiment of the present invention.

FIG. 2 is a top view of a floating body structure according to an embodiment of the present invention.

### DETAILED DESCRIPTION OF THE PRESENT INVENTION

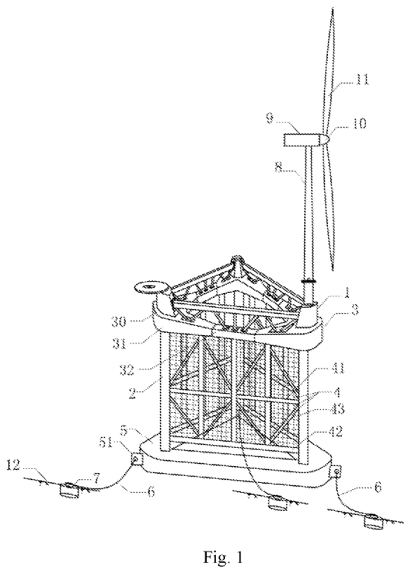

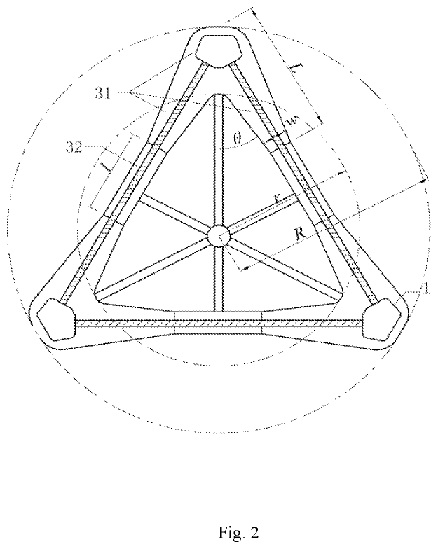

As shown in FIGS. 1 and 2, an embodiment provided herein by the present invention exemplifies an installation of one wind turbine set. The wind turbine set includes an upper structure, a polygonal deep-sea fishing net cage floating body, a steel cable 6 and a mooring system 7, and the upper structure includes a tower barrel 8, a blade 11, a nacelle 9, a hub 10, etc., all of which constitutes the offshore wind turbine set.

The polygon of the polygonal deep-sea fishing net cage floating body in this embodiment is substantially triangular. The polygonal deep-sea fishing net cage floating body includes an upper polygonal floating body frame 3, a bottom ring beam 5, and a middle truss structure between the upper floating body frame and the bottom ring beam.

The middle truss structure includes a connecting column 2 (and a buoyancy chamber or other structures could be disposed as needed), and the column 2 is disposed between the upper polygonal floating body frame and the bottom ring beam (generally disposed at a polygonal corner or inflection point); a connection structure 1 (generally disposed at a polygonal corner point) of the wind turbine set is disposed at the upper polygonal floating body frame, and the connection structure 1 may be a connection segment type. The root of the tower barrel 8 is connected to a flange of the connection structure 1 by a flange, so that the structure of the wind turbine set (tower, nacelle, hub, blade and internal attachment, etc.) can be connected with the upper polygonal floating body frame 3. The column 2 is usually disposed directly below the connecting structure 1 and is coaxial with the tower barrel 8 of the wind turbine set. The load on the upper structure can be quickly transmitted to the polygonal deep-sea fishing net cage floating body, and the forced condition, stability and resilience of the combined structure of the fishing net cage and the floating wind turbine foundation are improved.

The upper polygonal floating body frame is a floating body frame, which can adjust buoyancy and provide ballast by water injection. When the combined structure of a fishing net cage and floating wind turbine foundation is transported on the sea, the buoyancy is adjusted to a most suitable state for transportation. When the overall structure is in place, a required elevation is adjusted as designed during the operation period (operation of the wind turbine set and fisheries cage aquaculture). And the floating body frame is connected with the mooring system to provide reliable basis for enabling the wind turbine set operate in an optimal condition. The upper part of the floating body frame leaks out of the water surface, which provides activity or work spaces for work, operation and maintenance, etc. And the lower part is below the water surface which provides buoyancy and is connected with the middle truss structure.

The size of each polygonal corner portion 30 and surrounding polygonal edge portion of the upper polygonal floating body frame are determined by designing according to actual needs. The upper polygonal floating body frame is provided with a buoyancy chamber, and of which the size and position are determined by designing and calculating according to actual needs. In this embodiment, the buoyancy chamber of the upper polygonal floating body frame includes a corner-shaped buoyancy chamber 31 and a polygonal side buoyancy chamber 32 to increase buoyancy and ballast adjustment range and forced performance.

It may be disconnected between the buoyancy chambers so that balance adjustment can be made as needed. Each buoyancy chamber can be equipped with a hatch for water injection and drainage to control its buoyancy.

Assuming that the water depth ranges from 100 m˜150 m, geometry of the polygonal deep-sea fishing net cage floating body is as follows: an inner space of the polygonal deep-sea fishing net cage floating body is inscribed by a circle with radius r=62 m; the outermost edge is circumscribed by a circle with radius R=87 m; length of an outer buoy (buoyancy chamber 31) is L=53 m; length of an intermediate buoy (buoyancy chamber 32) is l=36 m; width of the end of the buoyancy chamber 31 is W=20 m, and the angle is θ=37° (see FIG. 2); and the height (the height of the column 2) between the upper polygonal floating body frame 3 and the bottom ring beam 5 is H=70 m. This embodiment can provide a net cage with a volume of about 100,000 cubic meters, while in specific construction; the size of the cage may be calculated and designed according to actual needs.

The truss structure is configured to connect the upper polygonal floating body frame with the bottom ring beam, and provides required space for fisheries aquaculture by providing with a mesh. A buoyant chamber providing buoyancy may be disposed according to actual needs. The middle truss structure includes the connecting column 2, a horizontal strut 41, a bottom beam 42 and a diagonal strut 43, and a mesh 4 is disposed on the horizontal strut 41, the bottom beam 42, the diagonal strut 43, and the column 2, if necessary, a chamber for providing buoyancy may be disposed as needed, and all aforementioned structures together constitute an aquaculture net cage space with “mesh closure”. The mesh can be made of copper to improve corrosion resistance.

The inner part of the polygonal deep-sea fishing net cage floating body constitutes an aquaculture area, which can be divided into a plurality of chambers for different types of fish culture. The chambers are separated by support members and the meshes to enhance the rigidity of the structure and facilitate different types of fish aquaculture.

A lifting net structure can be disposed in the net cage to complete the fishing through the lifting net.

The bottom of the polygonal deep-sea fishing net cage floating body, as a forced portion connected with the mooring of the mooring system, is provided with an interface 51 connected with the steel cable 6 of the mooring system 7, and the interface 51 can be disposed on the bottom ring beam. The floating body is connected and fixed to the mooring system 7 fixed on the sea floor 12 with the steel cable 6.

A plurality of the steel cable 6 may be applied, and each of the steel cable 6 connects the floating structure with the mooring system 7 anchored on the seabed to maintain the balance of the platform and adjust its stability. Appropriate specification and number of the steel cables need to be selected according to the required tension between the floating structure and the mooring system 7.

The mooring system 7 is designed according to a soil condition of the seabed, an environmental condition of the sea area and a required anchoring force of the overall structure. The type of the mooring system 7 may be a negative pressure barrel, a gravity type, a pile type or other fixed types.

In the present invention, the upper polygonal floating body frame may be designed into different geometric polygons as needed, such as a triangle, a quadrangle, etc. According to the design of a wind farm, the wind turbine set can be disposed at the part or each polygonal corner/inflection point of the upper polygonal floating body frame. The size of the polygonal deep-sea fishing net cage floating body is determined by designing and calculating according to the corresponding requirements of the wind turbine set spacing and the buoyancy provided by the floating body

The construction method of the present invention is as follows:

1. The foundation of the wind turbine set is a polygonal deep-sea fishing net cage floating body, which is prefabricated by an onshore processing plant and made of steel structures such as steel box type buoys, box beams and steel pipe. Connection between the floating body and the upper structure (tower barrel 8, engine room 9, wheel hub 10, blade 11, etc.) is completed by the connection structure 1 to produce a combined structure. Buoyancy of the combined structure is adjusted, and then the combined structure is floated by the tugboat to the deep-sea anchoring position.

2. After the combined structure is floated to the deep-sea anchorage position, the buoyancy and ballast are adjusted by loading water into the buoyancy chamber of the polygonal deep-sea fishing net cage, and the floating body is fixed by the steel cable with the previously constructed mooring system 7 and then a required elevation is adjusted as design to meet the stability requirements for an operation of wind turbine.

When the fisheries aquaculture is required to be performed, the mesh is fixed in the polygonal deep-sea fishing net cage floating body to provide area for cultivating fry.

The above description is only the specific embodiment of the invention, and the technical features of the present invention are not limited thereto, and any changes or modifications made by those skilled in the relevant art in the field of the invention are covered by the scope of the present invention.

What is claimed is:

1. A combined structure of a fishing net cage and a floating wind turbine foundation, comprising a wind turbine set, a polygonal deep-sea fishing net cage floating body and a mooring system;
the polygonal deep-sea fishing net cage floating body comprises an upper polygonal floating body frame, a bottom ring beam, and a middle truss structure provided between the upper polygonal floating body frame and the bottom ring beam;
the middle truss structure comprises a connecting column, and the connecting column is arranged between the upper polygonal floating body frame and the bottom ring beam;
a connection structure of the wind turbine set is arranged on the upper polygonal floating body frame;
the bottom of the polygonal deep-sea fishing cage floating body is provided with an interface connected with a steel cable of a mooring system;
buoyancy of the polygonal deep-sea fishing cage floating body is adjustable, and in which sub-tanks capable of providing ballast by loading water and buoyancy are arranged.

2. The combined structure of claim 1, wherein a connection structure of the wind turbine set is arranged on a polygonal corner or inflection point of the upper polygonal floating body frame; and the connecting column is arranged to connect the polygonal corner or inflection point of the upper polygonal floating body frame with the bottom ring beam.

3. The combined structure of claim 1, the bottom ring beam is a polygon consistent with the upper polygonal floating body frame; the connecting structure of the wind turbine set is disposed at the corner or inflection point of the upper polygonal floating body frame; and the connecting column is arranged to connect the corner or inflection point of the upper polygonal floating body frame with the corresponding corner or inflection point of the bottom ring beam.

4. The combined structure of claim 1, wherein the column is arranged directly below the connecting structure and is coaxial with a tower barrel of the wind turbine set.

5. The combined structure of claim 1, wherein the bottom ring beam is provided with an interface connected to a steel rope or a steel cable of the mooring system.

6. The combined structure of claim 1, wherein buoyancy of the upper polygonal floating body frame is adjustable; and the upper polygonal floating body frame comprises a sub-tank for loading water and providing buoyancy is provided.

7. The combined structure of claim 1, wherein a corner-shaped buoyancy chamber is disposed at a polygonal corner of the upper polygonal floating body frame.

8. The combined structure of claim 1, wherein an inner region of the polygonal deep-sea fishing net cage floating body constitutes a culture area, and a mesh of the polygonal deep-sea fishing net cage floating body is connected with the polygonal deep-sea fishing net cage floating body.

9. The combined structure of claim 1, wherein a maximum buoyancy provided by the polygonal deep-sea fishing net cage floating body is greater than a ballast of the combined structure of the fishing net cage and the floating wind turbine foundation during an operation period.
